(19) United States
(12) Patent Application Publication
(10) Pub. No.: US 2005/0288399 A1
(43) Pub. Date: Dec. 29, 2005

(54) Biodegradable plastic composition and producing method thereof

(76) Inventor: Ming-Tung Chen, Taipei (TW)

Correspondence Address: Allen, Dyer, Doppelt, Milbrath & Gilchrist, P.A.;401 Citrus center, 255 South Orange Avenue, Post Office Box 3791, Orlando, FL, 32802-3791, US

(21) Appl. No.: 11/080,281

(22) Filed: Mar. 15, 2005

(30) Foreign Application Priority Data
Jun. 25, 2004 (TW) 93118611

(51) Int. Cl. C08L 3/00

(52) U.S. Cl. 524/47

(57) ABSTRACT

A biodegradable plastic composition is provided. The biodegradable plastic composition includes a starch in a range from about 25% to about 50% by weight of the composition, a synthetic biodegradable resin in a range from about 10% to about 40% by weight of the composition, a synthetic resin with linear alkenes in a range from about 5% to about 15% by weight of the composition, an affinity agent in a range from about 8% to about 20% by weight of the composition, a coupling agent in a range from about 1% to about 3% by weight of the composition, and an additives in a range from about 1% to about 15% by weight of the composition. Further, a producing method of the biodegradable plastic also is provided.

### FIELD OF THE INVENTION

The present invention is related to a biodegradable plastic composition and a producing method thereof, and more particularly to a biodegradable plastic composition which is degraded completely under a compost condition and a producing method thereof.

### BACKGROUND OF THE INVENTION

In Taiwan, more than three billion plastic bags and more than eight thousand metric tons of agricultural mulch films are used every year, and the subsequent waste disposal process therefor would be a thorny problem. The waste disposal process usually includes the landfill, the incineration or the recycling. These plastic products are hardly degraded due to their persistent property while these plastic products are directly filled in the landfill. If these plastic products are incinerated in the incinerator, the toxic exhaust fumes including “Dioxin” would be generated therewith. Further, these plastic products are often greasy and dirty, and hence they are unable to be recycled. Besides, the plastic products include various materials and fail to be respectively marked or classified so that the recycle for the plastic products is not easy to be brought out. Furthermore, unlike the glass material or the metal material which allows the recycled products to have a similar property thereof, the physical property and the mechanical property of the recycled plastic products would be decreased gradually under every recycling treatment, and it often wastes much energy in the recycling treatment.

In fact, the plastic industry has been developed in the 70's age and many people have awoken to value of the treatment for waste plastics products. Further, scientists considered it was very possible to research some techniques to catalyze or reduce plastic materials at that time. Nevertheless, it was proved that whatever a catalyzer, a photosensitizer, a disintegrated agent or a reductant, was failed to treat these waste plastics products effectively.

Therefore, a new research aspect has been developed to study a new “material” from later of the 70's age. The new “material” is used to substitute for petrochemical materials, i.e. plastic products, and to decrease the environmental pollution resulted from the petrochemical materials. Therefore, people in the academic or the industrial fields have invested a lot of time to develop the biodegradable materials.

The new material is called as a biodegradable “green plastic”, which is derived from plants and manufactured by the biochemical refinement, fermentation or synthesis. Moreover, the physical property and the mechanical property of the biodegradable green plastic are similar to those of traditional plastic products so that the biodegradable green plastic could be used to substitute for the traditional plastic products.

The biodegradable materials would be very stable when being manufactured and used, but could be degraded and transformed into biomass energy, carbon dioxide and water within a proper time after wasting. The biomass energy is existed generally in the natural and benefits the environment because the ability for the carbon fixation in the formation process of the biomass energy is more than that of the incinerating process. The biomass energy of the biodegradable materials would be absorbed or used by plants, so that the biodegradable materials could be treated by composting and be recycled in the natural.

Nowadays, International Standards Organization (ISO) includes the following three standards for identifying the biodegradable materials: ISO 14851, ISO 14852 and ISO 14855, in which the ISO 14855 is so-called the China National Standard 14432 (CNS 14432) and it is the most exact one among these standards. Further, the ISO 14855 relates to a method for determination of the ultimate aerobic biodegradability and disintegration of plastic materials under the controlled composting conditions, i.e. Method by analysis of evolved carbon dioxide, which regulates that the release of the carbon dioxide should be measured under 20-25±° C. and the biodegradability calculated therefrom should be ≧90%.

Recently, the biodegradable plastic blended with starch and synthetic resin has been a most dominant type for the biodegradable plastic materials because of its lower price and better processing property. In addition, the synthetic resin is one of polyethylene (PE), polypropylene (PP), polystyrene (PS), and polyvinyl chloride (PVC) which is a common synthetic material with a hard degraded property. Nevertheless, many patents, researches, or documents concerning the infiltration capacity or denaturation for starch, the processing technique or the formula for the blended biodegradable plastic, and the resin modifying have been publicized. However, the fundamental property of the synthetic resin still is not changed in the blending process of the biodegradable plastic, so that the residual synthetic polymer, i.e. the synthetic resin of PE, PP, PS or PVC, of the biodegradable plastic still fails to be degraded even through starch contained therein been degraded completely. Therefore, this biodegradable plastic with the synthetic resin does not comply with the above-mentioned standards for the biodegradable materials and is not a real environmental product.

Presently, various manufacturing techniques for the biodegradable materials have been disclosed, such as a manufacturing process for producing a biodegradable copolymer with two random duplicate monomers and a manufacturing process for producing a biodegradable composition blended with a ethylene/vinyl alcohol copolymer and a destructurized starch. The biodegradable copolymer and the biodegradable composition exhibit a complete biodegradability and a better mechanical property, but the manufacturing process therefor has steps involving more complex chemical synthesis which are difficult and complex.

Therefore, a purpose of the present invention is to develop a new composition and producing process therefor to deal with the above situations encountered in the prior art.

### SUMMARY OF THE INVENTION

It is therefore a first aspect of the present invention to provide a biodegradable plastic composition and a producing method thereof including a simpler chemical composition and an easier manufacturing procedure with lower cost to produce a complete biodegradable product for complying with international environmental standards.

It is therefore a second aspect of the present invention to provide a biodegradable plastic composition and a producing method thereof, in which its product is granular and easy to integrate into the general plastic manufacturing process and thereby decreasing producing cost and enhancing producing efficiency.

According to the aspect of the present invention, a biodegradable plastic composition is provided. The biodegradable plastic composition includes a starch, a synthetic biodegradable resin, a synthetic resin with linear alkenes, an affinity agent, a coupling agent, and an accelerating agent. The starch is in a range from about 25% to about 50% by weight of the composition, the synthetic biodegradable resin is in a range from about 10% to about 40% by weight of the composition, the synthetic resin with linear alkenes in a range from about 5% to about 15% by weight of the composition, the affinity agent in a range from about 8% to about 20% by weight of the composition, the coupling agent in a range from about 1% to about 3% by weight of the composition, and the additives in a range from about 1% to about 15% by weight of the composition.

Preferably, the starch is dehydrated at a temperature ranged from 160 to 170° C.

Preferably, the starch is ultra-ground by adding a lubricating agent in a range from about 100% to about 150% by weight of the starch and a dispersing agent in a range from about 1% to about 5% by weight of the starch so that a particle size of the starch is smaller than 10 μm.

Preferably, the lubricating agent is a solvent with a relatively high boiling point being one selected from a group consisting of white oil, stearic acid, polyethylene wax, polyethylene oxide and a mixture thereof.

Preferably, the dispersing agent is 1,3-distearic glyceric ester (DSGE).

Preferably, the starch is a modified starch and is in a range from 25% to 50% by weight of the composition.

Preferably, the synthetic biodegradable resin is a synthetic biodegradable polymer with one of an ester side chain and a side chain being one selected from a group consisting of an ester group, a hydroxyl group, a carboxyl group and a ketone group.

Preferably, the synthetic biodegradable polymer is one selected from a group consisting of polycaprolactone (PCL), polylactic acid (PLA), polybutyl succinate (PBS) and a mixture thereof, and is in a range from 15% to 30% by weight of the composition.

Preferably, the synthetic resin with linear alkenes is an alkenes copolymer with at least one side chain being one selected from a group consisting of a hydroxyl group, a carboxyl group and an ester group.

Preferably, the alkenes copolymer is a copolymerized mixture being one selected from a group consisting of ethylene/vinyl acetate copolymer (EVA), ethylene/vinyl alcohol copolymer (EVOH), ethylene/acrylic acetate copolymer (EAA) and a mixture thereof.

Preferably, the copolymerized mixture is mixed with EAA and one of EVA and EVOH, and a mixture ratio of the EAA to one of the EVA and EVOH is ranged from 1 to 10.

Preferably, the affinity agent is glycerol and polyvinyl alcohol (PVA), and the coupling agent is organic peroxide, in which the organic peroxide is epoxide.

Preferably, the additives is one selected from a group consisting of calcium carbonate, calcium stearate, sec-butyl alcohol, ethyl acetate, silicate, sorbitol and mixtures thereof.

According to another aspect of the present invention, a method for producing a biodegradable plastic is provided. The method includes steps of (a) providing a composition having a starch, a synthetic biodegradable resin, a synthetic resin with linear alkenes, an affinity agent, a coupling agent and an additives, wherein the starch is in a range from about 25% to about 50% by weight of the composition, the synthetic biodegradable resin is in a range from about 10% to about 40% by weight of the composition, the synthetic resin with linear alkenes is in a range from about 5% to about 15% by weight of the composition, the affinity agent is in a range from about 8% to about 20% by weight of the composition, the coupling agent is in a range from about 1% to about 3% by weight of the composition, and the additives is in a range from about 1% to about 15% by weight of the composition, (b) performing an agitating process, (c) performing a compounding process, and (d) cooling and granulating to form the biodegradable plastic.

Preferably, the method further includes a process for preconditioning the starch before the step (a), and the process includes steps of (a1) dehydrating the starch under a temperature ranged from 160 to 170° C.; (a2) adding a lubricating agent in a range from about 100% to about 150% by weight of the starch and a dispersing agent in a range from about 1% to about 5% by weight of the starch, (a3) grinding under a high pressure ranged from 500 to 800 kilogram so as to form the starch with a particle size smaller than 10 μm, and (a4) separating the starch from an oil phase by a centrifuge.

Preferably, the agitating process in the step (b) is performed under an agitating rate ranged between 1000 and 2800 rpm, an agitating time ranged between 5 and 20 min and an agitating temperature ranged between 30 and 120° C.

Preferably, the agitating rate is preferably between 1400 and 1800 rpm and the agitating time is preferably between 6 and 15 min

Preferably, the agitating process is performed by a closed high-speed agitator and the compounding process is performed by a twin-screw extruder.

Preferably, the compounding process in the step (c) is performed under a compounding temperature ranged between 120 and 220° C. and preferably between 150 and 220° C., a compounding pressure ranged between 5 and 20 MPa and preferably between 8 and 15 MPa, and a compounding time ranged between 3 and 12 min and preferably between 5 and 10 min.

Preferably, more than 90% of the biodegradable plastic composition is degraded within 6 months under a compost condition, and then the biodegradable plastic composition is degraded completely within 1 year.

The above contents and advantages of the present invention will become more readily apparent to those ordinarily skilled in the art after reviewing the following detailed descriptions, in which:

### DETAILED DESCRIPTION OF THE PREFERRED EMBODIMENTS

The present invention will now be described more specifically with reference to the following embodiment. It is to be noted that the following descriptions of preferred embodiment of this invention are presented herein for purpose of illustration and description only; it is not intended to be exhaustive or to be limited to the precise form disclosed.

The accomplished method for producing a biodegradable plastic composition provided in the present invention includes starting steps of heavily dehydrating a starch in a range from 25% to 50% by weight of the composition under a temperature ranged from 160 to 170° C., adding a lubricating agent in a range from 100% to 150% by weight of the starch and a dispersing agent in a range from 1% to 5% by weight of the starch therein and ultra-grinding the starch under a high pressure ranged from 500 to 800 kilogram so as to form the starch with a particle size smaller than 10 μm, and then separating the starch from an oil phase by a centrifuge. Subsequently, the starch would be retrieved and then mixed with a synthetic biodegradable resin in a range from 10% to 40% by weight of the composition, a synthetic resin with linear alkenes in a range from 5% to 15% by weight of the composition, an affinity agent in a range from 8% to 15% by weight of the composition, a coupling agent in a range from 1% to 3% by weight of the composition, and an additives in a range from 1% to 15% by weight of the composition so as to form a mixed precursor. Further, the mixed precursor is agitated with a high speed in a closed agitator under an agitating time ranged between 5 and 20 min, an agitating rate ranged between 1000 and 2800 rpm, and an agitating temperature ranged between 30 and 100° C., and then is conveyed into a twin-screw extruder to be compounded therein under a compounding temperature ranged between 120 and 200° C., a compounding pressure ranged between 5 and 20 MPa and a compounding time ranged between 3 and 12 min so as to provide a compounded product. Therefore, under the compounding effect of a high temperature, a high pressure or a high shear force, the compounded product would be completely mixed and the partial side-chain groups thereof would be polymerized. Moreover, the final process is a step of cooling and granulating, and white granular products, i.e. the biodegradable plastic are produced thereby. Accordingly, it is very simple and fast for this producing process to be accomplished. Besides, the granular products could be introduced into a general plastic manufacturing process to produce various biodegradable plastic products.

Furthermore, the starch is a modified starch. The lubricating agent is a solvent with a relatively high boiling point being one selected from a group consisting of white oil, stearic acid, polyethylene wax, polyethylene oxide and a mixture thereof, and the dispersing agent is 1,3-distearic glyceric ester (DSGE). In addition, the synthetic biodegradable resin is a synthetic biodegradable polymer with one of an ester side chain and a side chain being one selected from a group consisting of an ester group, a hydroxyl group (OH), a carboxyl group and a ketone group, such as polycaprolactone (PCL), polylactic acid (PLA), polybutyl succinate (PBS) or mixtures thereof. The synthetic resin with linear alkenes is an alkene copolymer with at least one side chain being one selected from a group consisting of a hydroxyl group, a carboxyl group and an ester group, such as ethylene/vinyl acetate copolymer (EVA), ethylene/vinyl alcohol copolymer (EVOH), ethylene/acrylic acetate copolymer (EAA) or mixtures thereof, and the copolymerized mixture is preferably mixed with EAA and one of EVA and EVOH and a mixture ratio of the EAA to one of the EVA and EVOH is ranged from 0.1 to 10. The coupling agent is organic peroxide, such as epoxide. Moreover, the affinity agent is glycerol or PVA, and additives is one selected from a group consisting of calcium carbonate, calcium stearate, sec-butyl alcohol, ethyl acetate, silicate, sorbitol and mixtures thereof. Besides, the above-mentioned chemical elements or composing formula would be adjusted properly so as to be introduced into various plastic manufacturing processes, such as film blowing, injection molding and forming, or produce various product properties, such as strength, elasticity and hardness.

A. The First Experiment Example:

The preconditioning process includes steps of dehydrating starch in weight of 25 kg, adding the white oil in weight of 30 kg and DSGE in weight of 0.3 kg into the dehydrated starch and grinding it, and separating the starch by a centrifuge to be standby.

Subsequently, the starch in weight of 25 kg is retrieved and then mixed with polylactic acid (PLA) in weight of 30 kg, polybutyl succinate (PBS) in weight of 17 kg, ethylene-acrylate-acetate (EAA) in weight of 2 kg, thylene-vinylacetate copolymer (EVA) in weight of 3 kg, glycerol in weight of 10 kg, PVA 5 kg, epoxide in weight of 1 kg and an additives in weight of 7 kg. The above-mentioned mixing materials are agitated in a high-speed agitator under an agitating temperature of 80° C. an agitating time of 10 min and an agitating rate of 1400 rpm to generate a uniform white mixture.

The white mixture is conveyed into a twin-screw extruder through a hopper and is compounded therein under a compounding temperature ranged between 120 and 200° C., a compounding pressure ranged between 10 and 15 MPa and a compounding time of 5 min to produce a compounded product. The compounded product squeezed from the twin-screw extruder is cooled and granulated to form a white granular product, i.e. the biodegradable plastic, with a particle size about 2 mm. More than 90% of the granular product is degraded within 6 months under a compost condition, and then the organic carbon of the product is degraded almost completely within 1 year.

B. The Second Experiment Example:

The preconditioning process includes steps of dehydrating starch in weight of 40 kg, adding the white oil in weight of 50 kg and DSGE in weight of 0.5 kg into the dehydrated starch and grinding it, and separating the starch by a centrifuge to be standby.

Subsequently, the starch in weight of 35 kg is retrieved and then mixed with polycaprolactone (PCL) in weight of 37 kg, ethylene-acrylate-acetate (EAA) in weight of 2 kg, ethylene-vinyl alcohol (EVOH) in weight of 2 kg, glycerol in weight of 10 kg, PVA in weight of 7 kg, epoxide in weight of 2 kg and an additives in weight of 5 kg. The above-mentioned mixing materials are agitated in a high-speed agitator under an agitating temperature of 80° C., an agitating time of 10 min and an agitating rate of 1400 rpm to generate a uniform white mixture.

The white mixture is conveyed into a twin-screw extruder through a hopper and is compounded therein under a compounding temperature ranged between 120 and 185° C., a compounding pressure ranged between 5 and 15 MPa and a compounding time of 5 min to produce a compounded product. The compounded product squeezed from the twin-screw extruder is cooled and granulated to form a white granular product, i.e. the biodegradable plastic, with a particle size about 2 mm. More than 90% of the granular product is degraded within 6 months under a compost condition, and then the organic carbon of the product is degraded almost completely within 1 year.

C. The Third Experiment Example:

The preconditioning process includes steps of dehydrating starch in weight of 45 kg, adding the white oil in weight of 50 kg and DSGE in weight of 0.5 kg into the dehydrated starch and grinding it, and separating the starch by a centrifuge to be standby.

Subsequently, the starch in weight of 45 kg is retrieved and then mixed with polybutyl succinate (PBS) in weight of 30 kg, ethylene-acrylate-acetate (EAA) in weight of 2 kg, ethylene-vinyl alcohol (EVOH) in weight of 3 kg, glycerol in weight of 10 kg, PVA in weight of 5 kg, epoxide in weight of 1 kg and an additives in weight of 4 kg. The above-mentioned mixing materials are agitated in a high-speed agitator under an agitating temperature of 80° C., an agitating time of 10 min and an agitating rate of 1400 rpm to generate a uniform white mixture.

The white mixture is conveyed into a twin-screw extruder through a hopper and is compounded therein under a compounding temperature ranged between 120 and 200° C., a compounding pressure ranged between 10 and 15 MPa and a compounding time of 5 min to produce a compounded product. The compounded product squeezed from the twin-screw extruder is cooled and granulated to form a white granular product, i.e. the biodegradable plastic, with a particle size about 2 mm. More than 90% of the granular product is degraded within 6 months under a compost condition, and then the organic carbon of the product is degraded almost completely within 1 year.

Therefore, according to the above descriptions, the present invention has disclosed its mixing with degradable materials in the natural, i.e. modified starch and degradable polymers, to produce a biodegradable material which has better characteristics than the traditional plastics. The produced biodegradable material could comply with the international environmental standards and the waste management trend for recycling, pollution reduction, and resource conservation, and would be applied for manufacturing various kinds of green products.

In conclusion, it is understood that biodegradable plastic composition and a producing method thereof could provide a complete biodegradable plastic without synthetic resins of PE, PP, PS or PVC according to steps of selecting proper polymers and copolymers from existing synthetic biodegradable materials, mixing with proper ratio of modified starch, affinity agent and other additives, and performing a compounding process with a high temperature and a high pressure. The producing process of the present composition is very simple and easy to be performed so that the cost thereof would be decreased and the producing efficiency thereof would be enhanced. Further, a better reprocessing property and a better biodegradability in the present biodegradable plastic would be achieved

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A biodegradable plastic composition, comprising:
a starch in a range from about 25% to about 50% by weight of said composition;
a synthetic biodegradable resin in a range from about 10% to about 40% by weight of said composition;
a synthetic resin with linear alkenes in a range from about 5% to about 15% by weight of said composition;
an affinity agent in a range from about 8% to about 20% by weight of said composition;
a coupling agent in a range from about 1% to about 3% by weight of said composition; and
an additives in a range from about 1% to about 15% by weight of said composition.

2. The composition according to claim 1, wherein said starch is dehydrated at a temperature ranged from 1-60 to 170° C.

3. The composition according to claim 2, wherein said starch is ultra-ground by adding a lubricating agent in a range from about 100% to about 150% by weight of said starch and a dispersing agent in a range from about 1% to about 5% by weight of said starch so that a particle size of said starch is smaller than 10 μm.

4. The composition according to claim 3, wherein said lubricating agent is a solvent with a relatively high boiling point being one selected from a group consisting of white oil, stearic acid, polyethylene wax, polyethylene oxide and a mixture thereof.

5. The composition according to claim 3, wherein said dispersing agent is 1,3-distearic glyceric ester (DSGE).

6. The composition according to claim 1, wherein said starch is a modified starch.

7. The composition according to claim.6, wherein said starch is in a range from 25% to 40% by weight of said composition.

8. The composition according to claim 1, wherein said synthetic biodegradable resin is a synthetic biodegradable polymer with one of an ester side chain and a side chain being one selected from a group consisting of an ester group, a hydroxyl group, a carboxyl group and a ketone group.

9. The composition according to claim 8 wherein said synthetic biodegradable polymer is one selected from a group consisting of polycaprolactone (PCL), polylactic acid (PLA), polybutyl succinate (PBS) and a mixture thereof.

10. The composition according to claim 8 wherein said synthetic biodegradable polymer is in a range from 5% to 15% by weight of said composition.

11. The composition according to claim 1, wherein said synthetic resin with linear alkenes is an alkene copolymer with at least one side chain being one selected from a group consisting of a hydroxyl group, a carboxyl group and an ester group.

12. The composition according to claim 11, wherein said alkene copolymer is a copolymerized mixture being one selected from a group consisting of ethylene/vinyl acetate copolymer (EVA), ethylene-vinyl alcohol copolymer (EVOH), ethylene/acrylic acetate copolymer (EAA) and a mixture thereof.

13. The composition according to claim 12, wherein said copolymerized mixture is mixed with EAA and one of EVA and EVOH, and a mixture ratio of said EAA to one of said EVA and EVOH is ranged from 0.1 to 10.

14. The composition according to claim 1, wherein said affinity agent is one of glycerol and polyvinyl alcohol (PVA).

15. The composition according to claim 1, wherein said coupling agent is organic peroxide.

16. The composition according to claim 15, wherein said organic peroxide is epoxide.

17. The composition according to claim 1, wherein said additives is one selected from a group consisting of calcium carbonate, calcium stearate, sec-butyl alcohol, ethyl acetate, silicate, sorbitol and mixtures thereof.

18. A method for producing a biodegradable plastic, comprising steps of:
(a) providing a composition having a starch, a synthetic biodegradable resin, a synthetic resin with linear alkenes, an affinity agent, a coupling agent and an additives, wherein said starch is in a range from about 25% to about 50% by weight of said composition, said synthetic biodegradable resin is in a range from about 10% to about 40% by weight of said composition, said synthetic resin with linear alkenes is in a range from about 5% to about 15% by weight of said composition, said affinity agent is in a range from about 8% to about 20% by weight of said composition, said coupling agent is in a range from about 1% to about 3% by weight of said composition, and said additives is in a range from about 1% to about 15% by weight of said composition;
(b) performing an agitating process;
(c) performing a compounding process; and
(d) cooling and granulating to form said biodegradable plastic.

19. The method according to claim 18, further comprising a process for preconditioning said starch before said step (a), said process including steps of:
(a1) dehydrating said starch under a temperature ranged from 160 to 170° C.;
(a2) adding a lubricating agent in a range from about 100% to about 150% by weight of said starch and a dispersing agent in a range from about 1% to about 5% by weight of said starch;
(a3) grinding under a high pressure ranged from 500 to 800 kilogram so as to form said starch with a particle size smaller than 10μm; and
(a4) separating said starch from an oil phase by a centrifuge.

20. The method according to claim 18, wherein said agitating process in said step (b) is performed under an agitating rate ranged between 1000 and 2800 rpm, an agitating time ranged between 5 and 20 min and an agitating temperature ranged between 30 and 120° C.

21. The method according to claim 20, wherein said agitating rate is preferably between 1400 and 1800 rpm and said agitating time is preferably between 6 and 15 min.

22. The method according to claim 18, wherein said agitating process is performed by a closed high-speed agitator.

23. The method according to claim 18, wherein said compounding process in said step (c) is performed under a compounding temperature ranged between 120 and 220° C., a compounding pressure ranged between 5 and 20 MPa and a compounding time ranged between 3 and 12 min.

24. The method according to claim 23, wherein said compounding temperature is preferably between 150 and 220° C., said compounding pressure is preferably between 8 and 15 MPa and said compounding time is between 5 and 10 min.

25. The method according to claim 18, wherein said compounding process is performed by a twin-screw extruder.

26. The method according to claim 18, wherein more than 90% of said biodegradable plastic is degraded within 6 months under a compost condition, and then said biodegradable plastic composition is degraded completely within 1 year.
